(19) United States
(12) Patent Application Publication
(10) Pub. No.: US 2009/0283213 A1
(43) Pub. Date: Nov. 19, 2009

(54) CROSS-LINKING FILM ADHESIVES

(76) Inventors: Thomas Moller, Dusseldorf (DE); Guido Kollbach, Apex, NC (US); Pavel Gentschev, Dusseldorf (DE); Claudia Meckel-Jonas, Shanghai (CN); Norbert Bialas, Dormagen (DE)

Correspondence Address: Henkel Corporation, 10 Finderne Avenue, Bridgewater, NJ, 08807, US

(21) Appl. No.: 12/465,844

(22) Filed: May 14, 2009

Related U.S. Application Data
(63) Continuation of application No. PCT/EP2007/059824, filed on Sep. 18, 2007.

(30) Foreign Application Priority Data
Nov. 24, 2006 (DE) 10 2006 055 944.4

(51) Int. Cl. B32B 37/12; C09J 175/04; C09J 167/00; C09J 133/10; C09J 177/00; C09J 133/04

(52) U.S. Cl. 156/327; 524/538; 524/539; 524/502

(57) ABSTRACT

The invention relates to a two-component bonding agent system, consisting of a component A and a component B, comprising A) at least one polymer that possesses at least one Michael acceptor group, and in addition at least one Michael donor group, B) a compound catalyzing the Michael reaction, as well as optional additional additives and/or auxiliaries, wherein the polymer of component A has a number average molecular weight (Mₙ) between 1000 g/mol and 1 000 000 g/mol. Furthermore, 2K-adhesives, casting compounds and coating agents made from such bonding agent systems are described.

### CROSS REFERENCE TO RELATED APPLICATIONS

This application is a continuation of PCT/EP2007/059824 filed Sep. 18, 2007, which claims the benefit of DE 10 2006 055 944.4, filed Nov. 24, 2006, the complete disclosures of which are hereby incorporated by reference in their entirety.

### FIELD OF INVENTION

The invention relates to bonding agent systems that can be crosslinked by a Michael reaction and which can be employed in adhesives as a bonding agent system.

### BACKGROUND

Two-component bonding agent systems for use in adhesives are generally known. Thus, 2K PU adhesives have proven their worth in practice. However, these polyurethane adhesives have the disadvantage that as a consequence of the production process, fractions of low molecular weight, volatile isocyanates are comprised in the uncrosslinked adhesives. It is known, however, that when improperly handled these isocyanates can be hazardous to health. Consequently, many attempts have been made to develop adhesives that do not require isocyanate groups as the crosslinking system. Thus, bonding agent systems for adhesives are described in DE 10 2004 035542, wherein one component comprises reactive amino groups while the other component comprises cyclic carbonates as the reactive group.

Another chemical reaction is the Michael Addition, which comprises as the reactive groups a Michael donor and a Michael acceptor as the second functional group. Systems of this type are known for example from EP 1 283 235. Here, compositions are described that comprise polyfunctional α,β-unsaturated carboxylic acid esters as well as polymeric β-dicarbonyl compounds as the second component, wherein the polymers are described as polyesters or polyester amines.

EP 0 808 860 is also known for example, in which bonding agent mixtures based on polymers are likewise described, wherein one component possesses α,β-unsaturated carbonyl groups, the second component possesses a plurality of malonic ester groups and a catalyst is comprised as the third component that induces the Michael addition.

Further, EP 1 593 727 is known, in which two component systems are described, wherein a polymer having a large number of Michael acceptors is present in the first component, a polymer with a large number of Michael donors is in the second component, wherein a weakly basic catalyst must be comprised in the finished bonding agent mixture.

In addition, EP 1 435 383 is known. Here, Michael crosslinking bonding agent systems are described, wherein a layer of a mixture that comprises at least one polyfunctional Michael donor, at least one polyfunctional Michael acceptor and a strongly basic catalyst, is coated onto a substrate. Another substrate is subsequently bonded to the thus-coated substrate.

The compositions from the prior art each comprise a polymer or an oligomer, which comprises a plurality of Michael donor groups. In this document, polymers or oligomers, which contain a plurality of Michael acceptor groups, are described as the second component. Hence, such bonding agent systems are two component systems, wherein both reactive polymers are present in different components. In order to ensure an adequate crosslinking, a pre-determined mixing ratio must be maintained. The mixing ratio depends on the functionality of the reaction partners. Exact mixing is laborious. Moreover, compositions of this type often have a poor reactivity, with the result that special catalysts have to be employed.

### SUMMARY OF THE INVENTION

Therefore, the object of the present invention is to provide a bonding agent system that is suitable for a large number of fields of application, such as adhesives for hard or flexible substrates of different materials, as casting resins for components or for coating surfaces, wherein both crosslinking groups are present in one component, a catalyst mixture is provided as the second component, with which the crosslinking reaction of the mixture can be guaranteed.

The object is achieved by a two-component bonding agent system, consisting of a component A and a component B, comprising A) at least one polymer that possesses at least one Michael acceptor group, and in addition at least one Michael donor group, B) a compound catalyzing the Michael reaction, as well as optional additional additives and/or auxiliaries, wherein the polymer of component A has a number average molecular weight (Mₙ) between 1000 g/mol and 1 000 000 g/mol.

The invention further relates to a process for bonding flexible substrates with adhesives that crosslink by Michael addition. The invention further relates to a two-component adhesive based on a bonding agent system that crosslinks by Michael addition.

### DETAILED DESCRIPTION OF THE INVENTION

“Adhesive base polymers” are understood to mean thermoplastic synthetic polymers that determine critical properties for adhesives such as adhesion, tensile strength and temperature behavior. Examples of such polymers are thermoplastic elastomers; polymers such as ethylene-vinyl acetate, SIS, SBS, SEBS copolymers; polyolefins, such as amorphous or semi crystalline polyolefins, in particular propylene or ethylene homo or copolymers, reactive and non-reactive linear or branched thermoplastic polyurethanes; polyamide resins, copolyamides, such as polyether amides, polyester amides, polyesters, polyethers, polycarbonates, silicones or poly(meth)acrylates. Polymers of this type should possess more functional groups, such as OH—, NH—, NCO—, SH—, COOH groups that are capable of a further reaction.

Base polymers, from which the inventively functionalized bonding agents of component A can be manufactured, are in particular polyesters, polyethers, polyurethanes, polyamides, polyester amides, poly(meth)acrylates, copolymers based on vinyl esters, silicones or mixtures thereof. They should possess the abovementioned functional groups that can be modified to form Michael donor or Michael acceptor groups, or they possess one of the inventively required Michael functional groups directly when manufactured.

The “functional groups” that act as Michael donors are understood to mean groups that comprise one or two CH-acidic hydrogen atoms. They have the structure

Z—CHR—Z′

wherein

Z and Z′ can be independently electron withdrawing substituents such as aldehyde, ketone, ester, amide, anhydride, nitrile, nitro, sulfoxide or sulfone groups and R═Z. H or can be a C1 to C3 alkyl group. These functional groups are bonded to the polymer chain through the groups Z and/or Z′.

Groups of this type are present for example in compounds that are derived from β-dicarbonyl compounds, such as acetoacetic acid esters, malonic acid diesters or the corresponding amides, diketones or methanetricarboxylic acid esters; α-cyano-carbonyl derivatives, such as cyanoacetic acid or α-cyanoketo derivatives; bis-cyanomethylene derivatives, such as malononitrile; carbonyl derivatives with α-sulfoxide groups, such as sulfoacetic acid or the corresponding amides. Exemplary suitable compounds with this type of Michael donor activity are the dimethyl, diethyl, dibutyl, dipentyl esters of malonic acid, the methyl, ethyl, butyl, pentyl esters of acetoacetic acid, N-substituted acetamides or the methyl, ethyl, butyl esters of methanetricarboxylic acid.

According to the invention, at least one Michael donor group must be present in the polymer although a plurality of groups may be present. The CH-equivalent weight, based on the quantity of the acidic CH-groups, is generally between 100 and 5000, preferably 200 to 2000 g/mol. The number of the Michael donor groups depends on the molecular weight and the intended crosslinking density. In one embodiment, the polymer chain comprises between two and ten, especially up to five Michael donor groups.

Functional groups that act as Michael acceptors are understood to mean those that possess unsaturated double bonds and at least one electron-withdrawing substituent in the α-position. In particular they are α,β-unsaturated carbonyl compounds such as α,β-unsaturated aldehydes or ketones, acrylic acid derivatives, methacrylic acid derivatives, crotonic acid derivatives, itaconic acid derivatives, maleic acid derivatives, fumaric acid derivatives, citraconic acid derivatives, cinnamic acid derivatives, α-sulfonic- or phosphonic-substituted unsaturated compounds, such as vinylsulfonic derivatives, vinylphosphonic derivatives or nitro-styrene derivatives.

According to the invention, at least one Michael acceptor group must be present in the polymer. However, there can be two up to ten, especially up to five Michael acceptor groups, reacted into the polymer structure. They can be different functional Michael acceptor groups, but preferably they are the same functional groups.

Inventively suitable polymers must possess at least one Michael acceptor group and at least one Michael donor group in the molecule. One embodiment possesses one terminal Michael acceptor group or one Michael donor group, whereas the respective complimentary donor/acceptor groups are distributed along the polymer chain. Another embodiment possesses one terminal Michael acceptor group or one Michael donor group, the additional complimentary groups being distributed in one or a plurality of blocks in the polymer chain. In this case, the functional groups are reacted directly in the polymer chain or they are reacted on the polymer structure as side-chains. Another embodiment carries in each case only one different complementary group in a terminal position on the polymer chain. The sum of Michael acceptor groups and Michael donor groups should be ≧2.

The polymers should preferably be linear but it is also possible to introduce fractions of branched or star-shaped polymers. In this embodiment, the ends of the chain branches can likewise be functionalized by Michael acceptor groups and/or Michael donor groups.

The molecular weight (Mₙ) should be between 1000 g/mol and 1 000 000 g/mol (number average molecular weight as determined by GPC), especially between 2500 and 100 000 g/mol. When used in solvent-free systems it should preferably be up to 50 000 g/mol; in dissolved systems the lower limit can also be more than 10 000 g/mol. In order to obtain a flexible crosslinked polymer, the reacting functional groups in the polymer chain should be spaced wide apart; for this reason terminally complementary functionalized polymers having individual groups or having a block of the same groups are preferred. In order to obtain an as rigid as possible crosslinked polymer, the functional groups in the polymer chain should be spaced close to one another.

The inventively suitable polymers can be manufactured by methods known per se. One embodiment of the invention comprises polymers that as they are synthesized already comprise suitable Michael functional groups, such as unsaturated ester groups or amide groups or β-dicarbonyl groups. Another manufacturing process for suitable polymers uses the abovementioned base polymers. For this, the base polymers must still possess functional reactive groups. These are then treated with low molecular weight compounds having a molecular weight below 500, which each possess a functional group, Michael donor or Michael acceptor. By choosing the reaction partner, the polymer can then be selectively reacted with the Michael reactive groups. Care must be taken here that under the reaction conditions, no reaction occurs between the Michael donor groups and Michael acceptor groups that are possibly present at the same time.

Michael donor groups can be incorporated for example by transesterifying OH group-containing esters of for example malonic acid, acetoacetic acid, acetoacetic amides with carboxyl groups or ester groups present in the base polymer. Another reaction possibility is known, whereby for example isocyanate-functionalized β-dicarbonyl compounds are reacted with OH, SH or NH groups present on the polymer structure. Functionalized polymers with a Michael donor group are then obtained by the formation of a urethane or urea group. Likewise, with the formation of amides, amine-functionalized β-dicarbonyl derivatives can be obtained from the reaction of carboxyl or ester groups on the polymer chains. In this case, it should be noted that in order to avoid a premature reaction with the amino groups, the polymers must not comprise any Michael acceptor groups.

An inventively preferred process is to react H-active centers, such as OH, NH, COOH etc. that are present on the polymer with diisocyanates. In this way base polymers are obtained as intermediate products that comprise NCO groups. Without further isolation, they can be reacted in a second reaction step for example with hydroxy or amine functionalized β-dicarbonyl compounds or with the above described compounds. Polymers with defined amounts of Michael donor groups are then obtained.

A particular embodiment produces NCO-terminated reaction products from the base polymers. Said reaction products are subsequently reacted with not further functionalized Michael donor compounds that correspond to the cited Formula, in which R═H, for example diesters of malonic acid, esters of acetoacetic acid. The resulting polymers contain amido group-containing CH-acidic methine groups that can react as the inventively suitable Michael donor groups.

An analogous reaction methodology can build in Michael acceptor groups into the base polymer. For example, hydroxy-substituted alkyl esters of α,β-unsaturated carboxylic acids, hydroxy-substituted alkyl amides of unsaturated carboxylic acids can be transesterified with carboxylic groups or ester groups of the polymer. In another working method, as described above, OH, NH, SH or analogous groups of the base polymer are reacted with diisocyanates. These are then reacted in an additional reaction step with low molecular weight compounds containing OH, SH substituted α,β-unsaturated activated double bonds, such as those listed above as examples.

The general reaction procedures are known to the person skilled in the art and do not require any more detailed description. The reactions can optionally be facilitated by increased temperatures or special catalysts such that the polymer chains are not destroyed in the reaction. The sequence of the synthesis is chosen such that premature crosslinking does not occur. Suitable functionalized polymers can be manufactured which at the same time possess oppositely reactive Michael groups.

According to the invention, a compound that catalyzes the Michael reaction must be present as the component B. This consists of catalysts in the form of Lewis bases or Brönstedt bases, wherein the conjugated acids of the latter have a pKₐ of at least 10. In particular, they are amine-containing or amine-free bases. Exemplary amine-free bases are hydroxides or alkoxides of alkali metals such as LiOH, NaOH, KOH, NaH, KH, CaH₂, Na methoxide, Na ethoxide, K methoxide, K tert.-butoxide, potassium carbonate, calcium carbonate or similar compounds.

Lewis bases have proved to be particularly suitable, such as e.g. those of the group of cycloaliphatic amines, such as diazabicyclooctane (DABCO), tert.-aliphatic amines such as triethylamine, tripropylamine, tributylamine, N-methyldiethanolamine, N-methyldiisopropylamine or N-butyldiethanolamine, as well as amidines such as diazabicyclononene (DBN), diazabicycloundecene (DBU), and guanidines, such as e.g. N,N,N′,N′-tetramethylguanidine, pyridine derivatives, such as copolymers of 2,3,4-vinylpyridine or amine-containing acrylate copolymers, such as 2-dimethylaminoethyl acrylate, 2-diethylaminoethyl acrylate, or 3-dimethylaminopropyl acrylate. Further examples are alkyl or aryl substituted phosphanes, such as e.g. tributylphosphane, triphenylphosphane, tris-p-tolylphosphane, methyldiphenylphosphane, as well as hydroxy and amino functionalized phosphanes. Basic ion exchange resins are also suitable.

The component B can consist of one or more catalysts. It can also comprise additional auxiliaries that can form a homogeneous mixture with the catalyst. It is preferred to add inert auxiliaries to component B so as to enable a convenient handling when manufacturing a mixture of A) and B).

The components A and B result in an inventive 2-component bonding agent system. When mixed with additional ingredients, 2-component adhesives for example can be manufactured therefrom. One or both components can thus comprise still further auxiliaries or additives in addition to the described ingredients. Examples of these are plasticizers, inert additional binders, resins, plasticizers, waxes, adhesion promoters, pigments/fillers, viscosity regulators, optional solvents, leveling agents, stabilizers. These are generally known. These auxiliaries are selected according to the application purpose of the bonding agent system.

Plasticizers can be a further ingredient of such inventive adhesives. These plasticizers are preferably used to adjust the viscosity or the flexibility and are generally comprised at a concentration of 0 to 25 wt. %, preferably 2 to 15 wt. %. Exemplary suitable plasticizers are medicinal white oils, naphthenic mineral oils, oligomers of polypropylene, polybutene, polyisoprene, oligomers of hydrogenated polyisoprene and/or polybutadiene, benzoate esters, phthalates, adipates, vegetal or animal oils and derivatives thereof. Polypropylene glycol, polybutylene glycol or polymethylene glycol are also suitable.

The stabilizers have the task of protecting the adhesive composition from decomposition during processing. Here may be cited in particular antioxidants or also light stabilizers. They are usually added to the hot melt adhesive in quantities of up to 3 wt. %, preferably in quantities of about 0.1 to 1 wt. %.

Moreover, the inventive adhesive can comprise adhesion promoters. Adhesion promoters are substances that improve the adhesion of the adhesive to the substrate. In particular, adhesion promoters are intended to improve the aging behavior of adhesive bonds under the influence of humid atmospheres. They can also influence the wetting characteristics of the adhesive and thus the adhesion power.

The other types of additives, such as pigments, colorants, stabilizers, waxes or adhesion promoters are known to the person skilled in the art. They are commercial products and the person skilled in the art can choose them depending on the required properties. Care should be taken that they are compatible with the polymer mixture.

The additives can be comprised in one or in both components. Care should be taken that these substances do not react with the bonding agent or with the catalyst. They should be selected with a view to allowing good processability. It is advantageous when both components have a similar viscosity.

The inventive bonding agent system or the adhesives that can be manufactured from it, or other products, crosslink by mixing the component A with the catalyst in component B. This can be carried out batch wise or a continuous method can be selected. The crosslinking can be accelerated by increased temperatures.

The inventive bonding agent system is suitable for various applications. For example, it is possible to manufacture low viscosity adhesives. For this, the functionalized polymer can be dissolved in an organic solvent. It should essentially concern volatile solvents that can optionally be evaporated at an increased temperature of up to 100° C. Still more of the above listed additives can be comprised.

Another embodiment is a solvent-free adhesive. In this case the viscosity of the polymer is low enough to allow the above-cited additives to be blended in. Moreover it is also possible to add low molecular weight Michael reactive oligomers in such mixtures. These act as reactive diluents and can influence the viscosity of the bonding agent mixture. Examples of such reactive low molecular weight compounds are for example esters of polyhydric low molecular weight alcohols with malonic acid esters or β-dicarbonyl esters, which act as Michael donors; however, α,β-unsaturated carboxylic acid esters can be reacted, which then act as additional low viscosity Michael acceptors. “Low molecular weight” is understood to mean compounds with a molecular weight between 150 and 1500 g/mol, especially up to 800 g/mol.

A further subject matter of the invention is casting resins based on the bonding agent system. These are generally delivered with pumps, i.e. the compounds should be at least a highly viscous mixture. In this case the abovementioned additives or also finely dispersed pigments can be comprised.

The above-cited mixtures can be used for various applications. For example, adhesives can be manufactured, which can be film adhesives, lamination adhesives, structural adhesives, paper adhesives etc. Moreover, such compositions can also be used as casting resins. Another particular embodiment of the inventive polymer mixtures is the use as a coating. They can be in-mold coatings or substrates are provided on the surface with a suitable coating that can be subsequently crosslinked.

The bonding agent systems are particularly suitable for manufacturing adhesives, in particular as a two-component packaging or lamination adhesive.

The inventive adhesives demonstrate a good adhesion. They have the advantage that they neither comprise migratable nor volatile isocyanates nor decomposition products of isocyanates such as amines. If appropriate additional raw materials are selected then it is possible that adhesives of this type are suitable for foodstuff packaging or medicament packaging.

The adhesive bonds with the inventively suitable adhesives are flexible. They bond to a large number of different films such as PE films, PP films, polyamide films, PET films etc. Depending on the choice of the additives, one can ensure that colorless or transparent colorants can be manufactured. In a thin layer, these form highly adhesive composite films, which are highly adhesive even in the cold at low temperatures or also when warm.

### EXAMPLES

### Example 1

### OH-Terminated Malonate-Containing Polyester

Diethyl malonate (32 g) and neopentyl glycol (173 g) were mixed and heated to 150° C. under an inert gas (nitrogen). After 30 minutes, titanium tetraisopropoxide (0.2 g) was added and homogenized; the distilled-off condensate was collected and removed. At the end of the distillation a vacuum of 650 mbar was applied and reduced step wise to 10 mbar.

The viscosity of the product was 200 mPas (100° C.) and the OH number was 91.

The polyester (195 g) was mixed with MDI (59.4 g) with stirring and maintained at max. 100° C. for one hour. Stabilizer (BHT, 0.25 g) and 2-hydroxyethyl acrylate (16.4 g) were then added. Stirring was continued for four hours at increased temperature.

The viscosity of the resulting product was 6400 mPas (100° C.) (cone-plate viscosimeter, DIN-53229).

The resulting polymer was dissolved in ethyl acetate with a solids content of 35% (component A).

1,5-Diazabicyclo-(4,3,0)-non-5-ene in 10% conc. solution in ethyl acetate (component B) was manufactured as the component B.

The catalyst (0.1 wt. % solids) was added to component A, mixed and cast as a film onto a polymer film. The polymer film crosslinked at room temperature in 24 hours to form an elastic film.

1. A two-component bonding agent system comprising:
a) a component A comprising a base polymer with an average molecular weight (Mₙ) of 1,000 g/mol to 1,000,000 g/mol; and
b) a component B comprising (i) a polymer with at least one Michael acceptor group and at least one Michael donor group, (ii) a catalyst, and (iii) optionally additives and/or auxiliaries.

2. The two-component bonding agent system according to claim 1, wherein the base polymer of component A has an average molecular weight (Mₙ) of 1,500 g/mol to 100,000 g/mol.

3. The two-component bonding agent system according to claim 1, wherein the base polymer of component A is selected the group consisting of polyamide, polyester, polyether, polyurethane, poly(meth)acrylate, silicone, vinyl ester copolymers and mixtures thereof.

4. The two-component bonding agent system according to claim 1, wherein the sum of the Michael acceptor group and the Michael donor group is greater than or equal to 2 per polymer chain.

5. The two-component bonding agent system according to claim 1, wherein the Michael acceptor group and Michael donor group, independently of one another, is greater than or equal to 2 per polymer chain.

6. The two-component bonding agent system according to claim 1, wherein the Michael acceptor functional group or the Michael donor functional group is located terminally on the polymer.

7. The two-component bonding agent system according to claim 1, wherein the Michael acceptor group and the Michael donor group is located terminally on the polymer.

8. The two-component bonding agent system according to claim 1, wherein the polymer of (i) is linear.

9. The two-component bonding agent system according to claim 1, wherein the Michael donor group is β-dicarbonyl compounds, α-cyano-carbonyl derivatives, carbonyl derivatives with α-sulfoxide or α-sulfo groups or bis-cyanomethylene groups.

10. The two-component bonding agent system according to claim 1, wherein the catalyst is an amine-containing or amine-free base.

11. The two-component bonding agent system according to claim 1, wherein the additives and/or auxiliaries is less than 35 wt. % of the total system.

12. The two-component bonding agent system according to claim 1, wherein the adhesive is free of organic solvents and water.

13. The two-component bonding agent system according to claim 1, wherein the adhesive has a viscosity of less than 5,000 mPas at 50° C.

14. The two-component bonding agent system according to claim 1, wherein the component A further comprises a low molecular weight polymer with at least two Michael donor or Michael acceptor groups.

15. A process for bonding flexible substrates comprising:
a) applying the adhesive of claim 1 onto one flexible substrate surface;
b) evaporating volatile solvents; and
c) pressing a second flexible substrate surface onto the adhesive coated surface to form a substrate composite.

16. The process for bonding flexible substrates according to claim 16, wherein pressure is utilized in step c.

17. The process for bonding flexible substrates according to claim 16, wherein the substrate composite is heated at a temperature of 25° C. to 75° C.

18. The process for bonding flexible substrates according to claim 16, wherein the adhesive forms a storage-stable layer after step b.

19. An article comprising the two-component bonding agent system of claim 1.

20. The article of claim 19 which is a flexible substrate composite.
